(19) United States
(12) Patent Application Publication
(10) Pub. No.: US 2013/0290019 A1
(43) Pub. Date: Oct. 31, 2013

(54) Context Based Medical Documentation System

(71) Applicants: James Pressler, Exton, PA (US); Smita Krishnan, Malvern, PA (US); Alfred George Tiemann, III, Churchville, PA (US); Arnold Teres, Broomall, PA (US)

(72) Inventors: James Pressler, Exton, PA (US); Smita Krishnan, Malvern, PA (US); Alfred George Tiemann, III, Churchville, PA (US); Arnold Teres, Broomall, PA (US)

(73) Assignee: SIEMENS MEDICAL SOLUTIONS USA, INC., Malvern, PA (US)

(21) Appl. No.: 13/456,397

(22) Filed: Apr. 26, 2012

(51) Int. Cl. G06Q 50/24

(52) U.S. Cl. 705/3

(57) ABSTRACT

A system populates a medical imaging examination report of a patient with generated text. An interface receives a patient identifier and data identifying characteristics of a medical imaging examination. At least one repository stores information derived using the patient identifier and the data identifying characteristics of the medical imaging examination. The information associates patient medical history data including, a patient diagnosis and a patient prior medical condition with medical imaging examination type and image acquisition characteristics including anatomical region imaged. A report processor uses the information in automatically selecting a text phrase from multiple predetermined text phrases. The report processor automatically populates the selected text phrase into a medical imaging examination report and prompts user data entry.

### FIELD OF THE INVENTION

This invention concerns a system for populating a medical imaging examination report of a patient with text selected in response to information associating patient medical history data with medical imaging examination type and image acquisition characteristics, for example.

### BACKGROUND OF THE INVENTION

In a healthcare organization, it is desirable for a user to be able to quickly and accurately generate medical documentation of patient encounters such as visits, patient procedures and other treatment including imaging examinations, for example. Known systems provide “voice shortcuts” or “voice macros” in which a user utters a phrase e.g. “Powerscribe CT brain” which triggers automatic insertion of a text string. For example, the text associated with a voice shortcut “Powerscribe CT brain” might be: “CT of the brain is performed with and without iodinated contrast. The ventricles appear normal in size and position. There is no swelling, mass, or mass effect noted”. Known systems dynamically generate a voice shortcut associated with a medical procedure or specific data stored in a voice database about the procedure. For example, if the voice system database includes a field for the gall bladder wall thickness, that value can be included into a voice shortcut automatically. In such an example, the utterance “Powerscribe gallbladder wall” might trigger the insertion of the text: “The gall bladder wall measures 4 mm in thickness” (where the 4 was inserted into the voice shortcut).

In a known system a user selects an imaging study (e.g., CT of the chest) to interpret and document and a voice recognition system is activated. A user utters a voice shortcut (e.g. “Powerscribe CT chest”) to trigger insertion of text and the voice recognition system inserts the text phrase that is associated with the voice shortcut. Known systems provide an ability for a user to manually create documentation or to use templates which can be pre-populated. Known systems do not comprehensively consider the context in which the medical documentation is being created. As a result, a user requires more time to complete documentation. Also, because known systems require more manual intervention, these systems are more error-prone. A system according to invention principles addresses these deficiencies and associated problems.

### SUMMARY OF THE INVENTION

A text string generator system employs user, patient, procedure, location, and other contextual information to dynamically generate and format text for inclusion in medical documentation such as a radiology result report. A system populates a medical imaging examination report of a patient with generated text. An interface is configured for receiving a patient identifier and data identifying characteristics of a medical imaging examination performed on the patient. At least one repository stores information derived using the patient identifier and the data identifying characteristics of the medical imaging examination. The information associates patient medical history data including, a patient diagnosis and a patient prior medical condition with medical imaging examination type and image acquisition characteristics including anatomical region imaged. A report processor is configured for using the information in automatically selecting a text phrase from multiple predetermined text phrases. The report processor automatically populates the selected text phrase into a medical imaging examination report together and generates a prompt message for prompting a user for entry of patient specific report data.

### BRIEF DESCRIPTION OF THE DRAWING

FIG. 1 shows a system for populating a medical imaging examination report of a patient with generated text, according to an embodiment of the invention.

FIG. 2 shows a flowchart of a process for expediting creation of medical documentation (e.g. result reports, nursing notes), according to an embodiment of the invention.

FIGS. 3, 4 and 5 show lookup tables associating multiple different context variables with text to be automatically incorporated into a medical examination report, according to embodiments of the invention.

FIG. 6 shows a flowchart of a process performed by a system for populating a medical imaging examination report of a patient with generated text, according to an embodiment of the invention.

### DETAILED DESCRIPTION OF THE INVENTION

A system according to invention principles uses data indicating a context in which medical documentation is being created to automatically generate more accurate and complete medical documentation advantageously reducing worker time involved and reducing documentation errors. The system expedites medical documentation creation by pre-populating and formatting text fields based on context including identity of user, workstation, location, patient, procedure, time of day, user specialization and other contextual information, in which the medical documentation is being created. A text string generator system employs the contextual information to dynamically generate and format text for inclusion in medical documentation such as a radiology result report. The text generator expedites the creation of medical documentation (e.g. result reports, nursing notes) by using details about the context in which the documentation is being created to generate and format text strings for inclusion in the medical documentation.

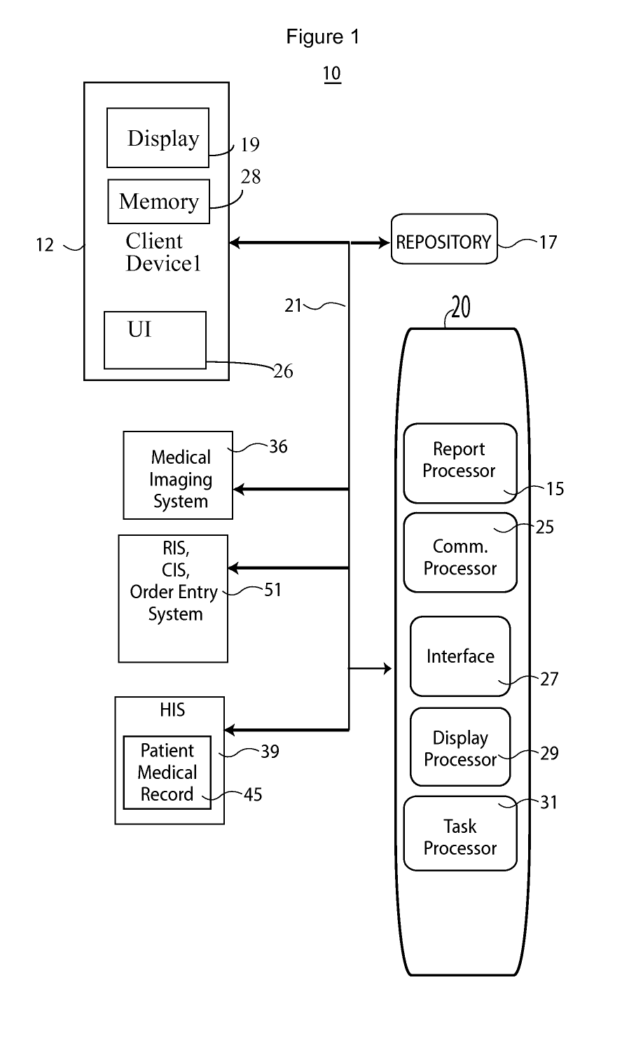

FIG. 1 shows system 10 for populating a medical imaging examination report of a patient with generated text. System 10 includes one or more processing devices (e.g., workstations, computers or portable devices such as notebooks, Personal Digital Assistants, phones) 12 that individually include a user interface 26 enabling user interaction with a Graphical User Interface (GUI) and display 19 supporting GUI and medical image presentation in response to predetermined user (e.g., physician) specific preferences. System 10 also includes at least one repository 17, medical imaging system 36, Healthcare Information System (HIS) 39 storing patient medical record 45, Radiology Information System (RIS), Clinical Information System (CIS) and Order entry system 51 and server (computer) 20. Server 20 includes interface 27, report processor 15, display processor 29, task processor 31 and communication processor 25. Imaging device 36 comprise a single device (e.g., a mono-plane or biplane X-ray imaging system, computed tomography (CT) system, MR system or Ultrasound system). The units of system 10 intercommunicate via network 21. At least one repository 17 stores medical image studies for patients in DICOM compatible (or other) data format. A medical image study individually includes multiple image series of a patient anatomical portion which in turn individually include multiple images. Imaging device 36 acquires multiple sequential images (which may or may not be synchronized with ECG and respiratory signals) of a patient volume of interest. At least one repository 17 stores 2D image data or a 3D image volume dataset representing an imaging volume.

Interface 27 is configured for receiving a patient identifier and data identifying characteristics of a medical imaging examination performed on the patient. At least one repository 17 stores information derived using the patient identifier and the data identifying characteristics of the medical imaging examination. The information associates patient medical history data acquired from patient record 45 in HIS 39 including, a patient diagnosis and a patient prior medical condition with medical imaging examination type and image acquisition characteristics including anatomical region imaged. Report processor 15 is configured for using the information in automatically selecting a text phrase from multiple predetermined text phrases and for automatically populating the selected text phrase into a medical imaging examination report together with a prompt message for prompting a user for entry of patient specific report data. Task processor 31 automatically alters a task schedule of a worker in response to the prompt message. Display processor 29 initiates generation of data representing a display image, enabling viewing of the medical imaging examination report. Communication processor 25 automatically uses the received patient identifier in identifying patient medical record 45 and acquiring data indicating the patient diagnosis, the prior medical condition and a current patient medication.

System 10 is usable with voice recognition and dictation systems and in dynamic text generation for entering data and text messages as well as selecting text messages and responding to prompts. The system comprehensively takes into account context information concerning a reporting experience, including aspects of a user, temporal and spatial considerations (e.g. location, day of week, time of day), the history of an imaging study or procedure (e.g. how many prior similar studies has the patient had and a patient admitting diagnosis, for example), and other context factors to determine a text message or voice shortcut content. In system 10 a user selects an imaging study (e.g., CT of the chest) to interpret and document and a voice recognition system (not shown to preserve drawing clarity) in report processor 15 is activated and in response to the type of imaging study that is selected, the system automatically inserts a text phrase that is associated with the procedure. The user is not required to utter any voice shortcut.

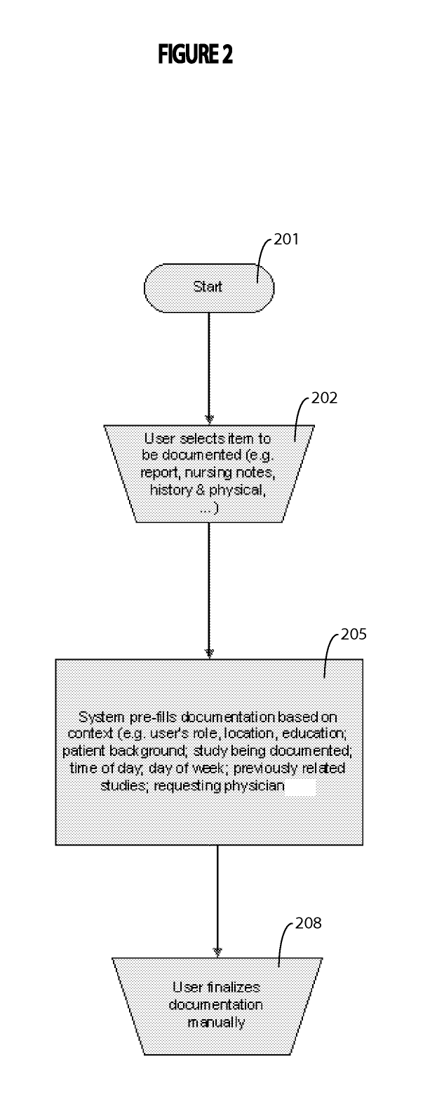

FIG. 2 shows a flowchart of a process employed by system 10 (FIG. 1) for expediting creation of medical documentation (e.g., result reports, nursing notes). In step 202, following the start at step 201, a user such as a radiologist, nurse or physician, selects an item to be documented such as an X-ray medical imaging study report, nursing notes, a history and physical report. In step 205, at the time a text phrase is to be inserted into a report or other document, report processor 15 evaluates current context information in a lookup table (identity of user, workstation on which report is being accessed, location of workstation, patient, procedure concerned, time of day, day of week, user (physician) specialization, weather conditions, patient history, requesting/referring physician ordering patterns, user role, education of user and patient, type of study being documented for example) and uses the information to pre-populate a report and determine appropriate text to insert in the report. Processor 15 adaptively and dynamically selects a text phrase to be inserted, or portions of a predetermined text phrase to be inserted accommodating different contextual variations, for example. In step 208, the user manually finalizes and stores the report in repository 17.

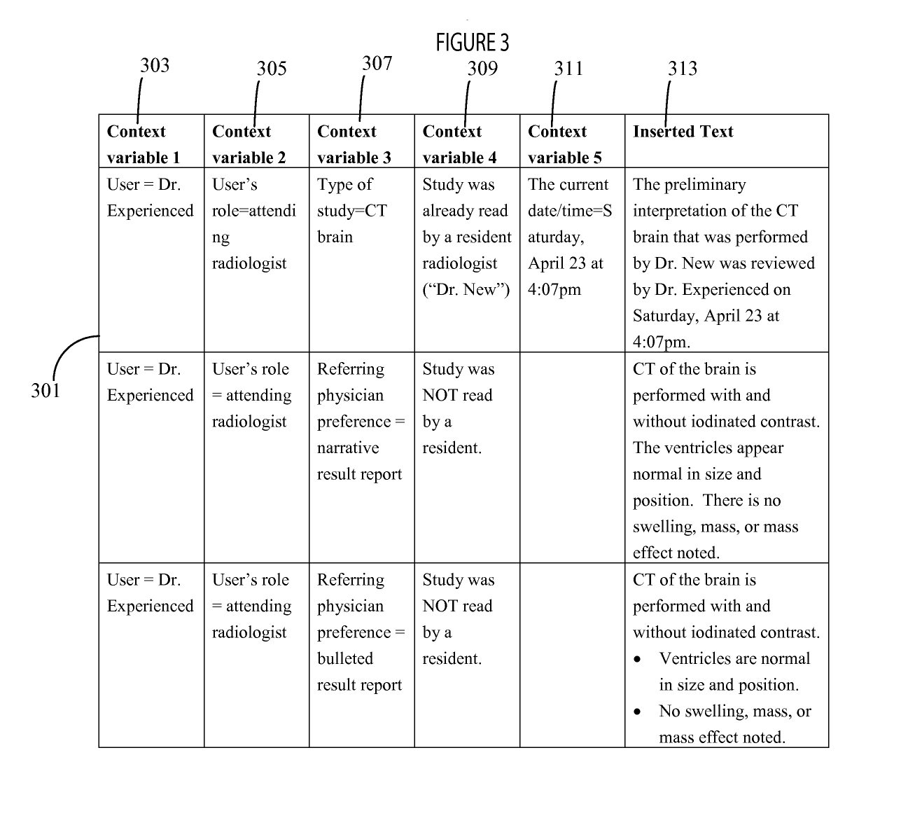

FIGS. 3, 4 and 5 show lookup tables in repository 17 associating multiple different context variables with text to be automatically incorporated into a medical examination report. Table 301 FIG. 3 associates context variables including user identity 303, user role 305, type of report 307, status of review of an imaging study 309, current date and time, 311 with text phrases 313 to be inserted into a report. In the Table 301 example, a user is the same person (“Dr. Experienced”) reading the same type of study (a CT brain study). Report processor 15 uses the context as indicated by context variables 303, 305, 307, 309 and 311 of table 301 in which the study is being read to determine the most appropriate text 313 to insert in a report and to determine format of an inserted text phrase and report.

Report processor 15 constructs a text phrase based on a variety of contextual conditions as predetermined in configuration data in table 301 (and tables 401, 501, for example). Processor 15 employs different rules in a lookup table to determine content and format of text automatically populated in a report. A configuration processor (not shown to preserve drawing clarity) in processor 15 advantageously enables a user to determine automatic text population rules in table 301. For example, a user employs the configuration processor to configure a rule that determines, “If I am reading a CT abdomen for a 7-year-old female patient and the gallbladder wall thickness is 1.5 mm, insert the text: ‘CT abdomen (pediatric) is performed on a 7-year-old girl. The gall bladder wall thickness is 1.5 mm, which is beneath the healthy range (2.5 mm-4 mm) for a patient of this age’.

System 10 enables a user to build a library of complex rules which take into account different contextual variables that are encountered in a healthcare setting, including user role, type of medical procedure concerned, patient clinical history and identity of report recipient, for example. A user configures rules and a rule hierarchy that indicates an order in which to apply rules used to generate text. The system automatically accumulates rules in a learning mode based on user preferences. As a physician uses particular voice or entered text for a particular type of patient (with particular demographics age, weight, height, gender) and a particular imaging study type, (e.g. CT, X-ray, MR, Ultrasound), the system automatically stores user voice text or entered written text for one patient for other patients of similar demographics and imaging study types.

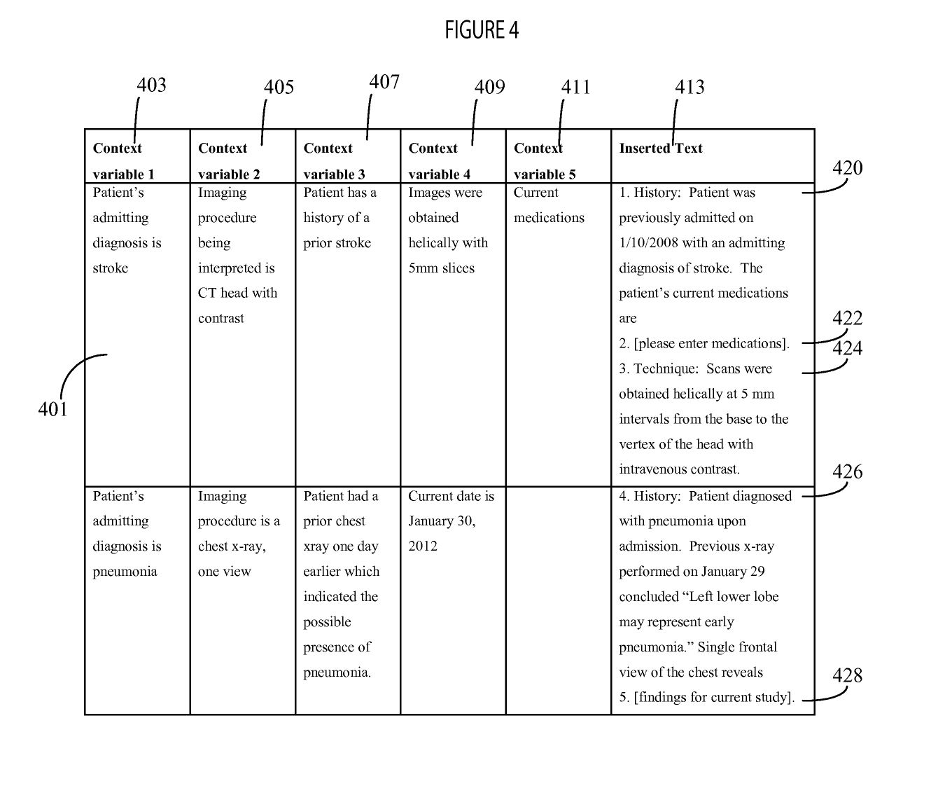

FIG. 4 shows lookup table 401 in repository 17 associating multiple different context variables with text to be automatically incorporated into a medical examination report. Table 401 associates context variables including patient admitting diagnosis 403, imaging procedure type 405, patient medical history 407, type of image acquisition (e.g. CT helical scan with 5 mm slice) or current date and time 409 and current medications 411, with text phrases 413 to be inserted into a report. Report processor 15 uses the context as indicated by context variables 403, 405, 407, 409 and 411 of table 401 in which the study is being read to determine the most appropriate text to insert in a report and to determine format of an inserted text phrase and report. Processor 15 uses the association of context variables 403, 405, 407, 409 and 411 to automatically generate text items 1 (420), 3 (424) and 4 (426) as portions of text to be inserted and to populate a patient imaging report with the generated text at the time of report creation. The text is generated without user manual selection and entry of items 1 (420), 3 (424) and 4 (426). In response to user mandatory input automatically prompted by automated speech or via a display image message, processor 15 uses the association of context variables 403, 405, 407, 409 and 411 to automatically generate text items 2 (422) and 5(428) portions and automatically insert these items in the report. Processor 15 prompts a user to enter patient medications for incorporation as text item 2 (422) and to enter findings of an imaging study as text item 5 (428), for example. System 10 requires that a user documents medications a patient is taking and inhibits indication a report is complete until a user enters the medication information.

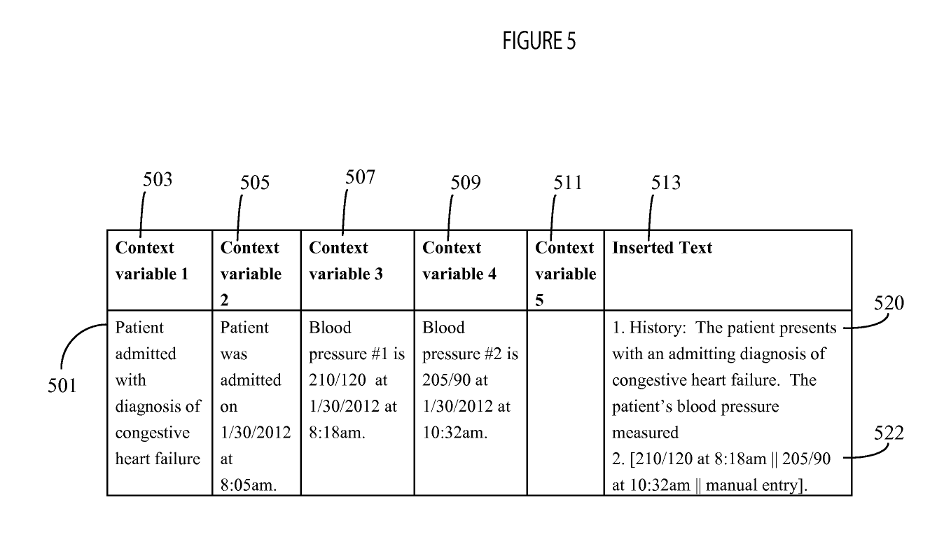

FIG. 5 shows lookup table 501 in repository 17 associating multiple different context variables with text to be automatically incorporated into a medical examination report. Table 501 associates context variables including patient admitting diagnosis 503, patient admission date and time 505, a first blood pressure reading at a first time and date 507, a second blood pressure reading at a second time and date 509 and another context variable 511, with text phrases 513 to be inserted into a report. Report processor 15 uses the context as indicated by context variables 503, 505, 507, 509 and 511 of table 501 in which the study is being read to determine the most appropriate text to insert in a report and to determine format of an inserted text phrase and report. Processor 15 uses the association of context variables 503, 505, 507, 509 and 511 to automatically generate text items 1 (520) and 2 (522) as portions of text to be inserted and to populate a patient imaging report with the generated text at the time of report creation.

In this embodiment, report processor 15, in addition to automatically inserting text content based on lookup table variable association and interpretation data in a system concerning patient and context, the system prompts a user with a list of choices. For example, if the patient has two blood pressure measurements 507, 509 entered into the system within the last 24 hours, a data selection option is automatically incorporated within the body of the text to prompt a user to choose either of the measurements, an average, or a manual entry. In table 501 text item 1 (522) is automatically populated into a report in response to the association of context variables 503, 505, 507, 509 and 511 known at the time of report creation. Processor 15 generates a prompt to a user to select. [210/120 at 8:18 am | or | 205/90 at 10:32 am | (item 2 (522)) or to enter blood pressure manually.

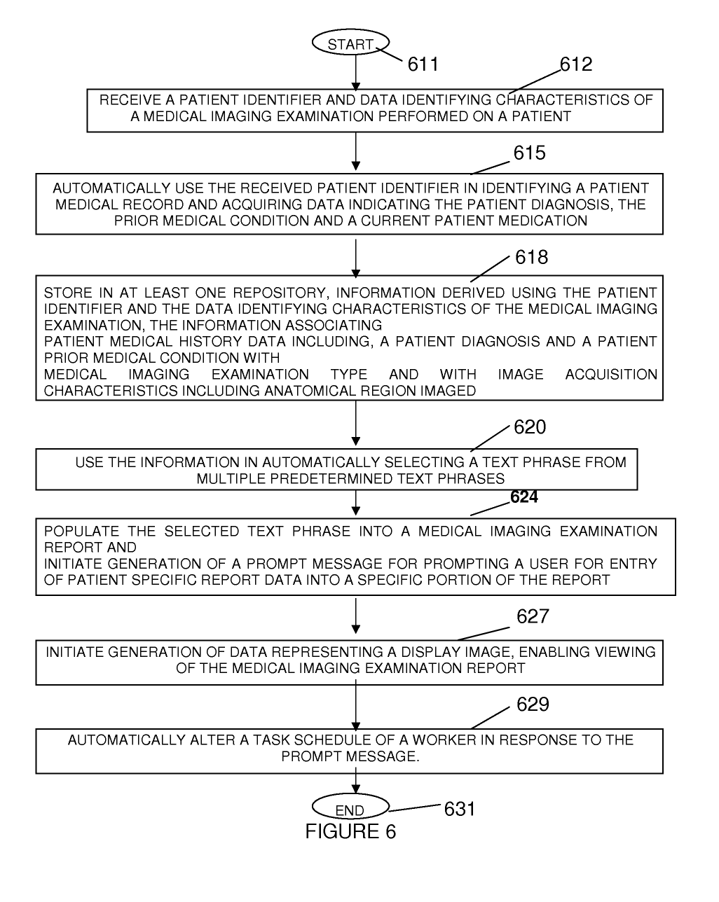

FIG. 6 shows a flowchart of a process performed by system 10 for populating a medical imaging examination report of a patient with generated text. In step 612 following the start at step 611, interface 27 receives a patient identifier and data identifying characteristics of a medical imaging examination performed on the patient. In step 615, communication processor 25 automatically uses the received patient identifier in identifying patient medical record 45 and acquiring data indicating the patient diagnosis, the prior medical condition and a current patient medication. Communication processor 25 also automatically acquires data indicating a medical imaging examination type and image acquisition characteristics from imaging examination system 36. The medical imaging examination type comprises at least one of, (a) an MR type, (b) a computed tomography (CT) type, (c) an X-ray type and (d) an Ultrasound type. The image acquisition characteristics comprise at least one of, (a) a CT scanning trajectory, (b) an MR pulse sequence, (c) an acquired image slice thickness, (d) use of contrast agent, (e) an angle or orientation of imaging and (f) type of synchronization.

Report processor 15 in step 618, stores in at least one repository 17, information derived using the patient identifier and the data identifying characteristics of the medical imaging examination. The information associates patient medical history data including, a patient diagnosis and a patient prior medical condition with medical imaging examination type and image acquisition characteristics including anatomical region imaged. The information includes data associating a user identifier of a physician providing a second opinion with the patient and the patient medical history data and data associating a user identifier and user role with the patient and the patient medical history data.

In step 620 report processor 15 uses the information in automatically selecting a text phrase from multiple predetermined text phrases and processor 15 automatically selects a prompt message from multiple predetermined prompt messages. The report processor automatically selects the text phrase from the multiple predetermined text phrases associated with multiple different user roles. The multiple predetermined text phrases are customized based on user preference and are associated with multiple different users. In one embodiment, the report processor automatically selects the text phrase from the multiple predetermined text phrases in response to the user identifier and data identifying whether or not an image has been reviewed by the physician.

Processor 15 in step 624 automatically populates the selected text phrase into a medical imaging examination report and initiates generation of a prompt message for prompting a user for entry of patient specific report data into a specific portion of the report. Display processor 29 in step 627 initiates generation of data representing a display image, enabling viewing of the medical imaging examination report. In step 629 task processor 31 automatically alters a task schedule of a worker in response to the prompt message. The task processor automatically adds a data item identifying a task to a task schedule of a worker in response to data entered into the medical imaging examination report. The process of FIG. 6 terminates step 631.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command An activity (including a step) performed automatically is performed in response to executable instruction or device operation without user direct initiation of the activity. Any of the functions and steps provided in the Figures may be implemented in hardware, software or a combination of both. No claim element herein is to be construed under the provisions of 35 U.S.C. 112, sixth paragraph, unless the element is expressly recited using the phrase “means for.”

The system and processes of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system uses a text string generator to dynamically generate and format text data and automatically pre-populate and format text fields in response to context including identity of user, workstation, location, patient, procedure, time of day, user specialization and other contextual information, in which the medical documentation is being created. Further, the processes and applications may, in alternative embodiments, be located on one or more (e.g., distributed) processing devices on a network linking the units of FIG. 1. Any of the functions and steps provided in FIGS. 1-6 may be implemented in hardware, software or a combination of both.

What is claimed is:

1. A system for populating a medical examination report of a patient with generated text, comprising:
an interface configured for receiving a patient identifier and data identifying characteristics of a medical examination performed on said patient;
at least one repository of information derived using said patient identifier and said data identifying characteristics of said medical examination, said information associating
patient medical history data including, a patient diagnosis and a patient prior medical condition with
medical examination type and image acquisition characteristics including anatomical region imaged; and
a report processor configured for using said information in automatically selecting a text phrase from a plurality of predetermined text phrases, said report processor automatically populating the selected text phrase into a medical examination report and initiating generation of a prompt message for prompting a user for entry of patient specific report data into a specific portion of said report.

2. The system according to claim 1, wherein said
medical examination report comprises at least one of, (a) a nursing report, (b) a history and physical report and (c) a medical imaging report.

3. A system for populating a medical imaging examination report of a patient with generated text, comprising:
an interface configured for receiving a patient identifier and data identifying characteristics of a medical imaging examination performed on said patient;
at least one repository of information derived using said patient identifier and said data identifying characteristics of said medical imaging examination, said information associating
patient medical history data including, a patient diagnosis and a patient prior medical condition with
medical imaging examination type and image acquisition characteristics including anatomical region imaged; and
a report processor configured for using said information in automatically selecting a text phrase from a plurality of predetermined text phrases, said report processor automatically populating the selected text phrase into a medical imaging examination report and initiating generation of a prompt message for prompting a user for entry of patient specific report data into a specific portion of said report.

4. The system according to claim 3, including
a display processor configured for initiating generation of data representing a display image, enabling viewing of the medical imaging examination report.

5. The system according to claim 3, including
a task processor configured for automatically altering a task schedule of a worker in response to said prompt message.

6. The system according to claim 3, wherein
said report processor automatically selects said prompt message from a plurality of predetermined prompt messages.

7. The system according to claim 3, including
a communication processor for automatically using the received patient identifier in identifying a patient medical record and acquiring data indicating said patient diagnosis, said prior medical condition and a current patient medication.

8. The system according to claim 3, including
a communication processor for automatically acquiring data indicating said medical imaging examination type and image acquisition characteristics from an imaging examination system.

9. The system according to claim 3, wherein
said medical imaging examination type comprises at least one of, (a) an MR type, (b) a computed tomography (CT) type, (c) an X-ray type and (d) an Ultrasound type.

10. The system according to claim 9, wherein
said image acquisition characteristics comprise at least one of, (a) a CT scanning trajectory, (b) an MR pulse sequence, (c) an acquired image slice thickness, (d) use of contrast agent, (e) an angle or orientation of imaging and (f) type of synchronization.

11. The system according to claim 3, further comprising
a task processor for automatically adding a data item identifying a task to a task schedule of a worker in response to data entered into said medical imaging examination report.

12. The system according to claim 3, wherein
said at least one repository includes data associating a user identifier and user role with said patient and said patient medical history data and
said report processor automatically selects said text phrase from said plurality of predetermined text phrases associated with a plurality of different user roles.

13. The system according to claim 12, wherein
said plurality of predetermined text phrases are customized based on user preference and are associated with a plurality of different users and
said report processor automatically selects said text phrase from said plurality of predetermined text phrases in response to said user identifier.

14. The system according to claim 3, wherein
said at least one repository includes data associating a user identifier of a physician providing a second opinion with said patient and said patient medical history data and
said report processor automatically selects said text phrase from said plurality of predetermined text phrases in response to data identifying whether or not an image has been reviewed by said physician.

15. A method for populating a medical imaging examination report of a patient with generated text, comprising the steps of:
receiving a patient identifier and data identifying characteristics of a medical imaging examination performed on said patient;
storing in at least one repository, information derived using said patient identifier and said data identifying characteristics of said medical imaging examination, said information associating
patient medical history data including, a patient diagnosis and a patient prior medical condition with
medical imaging examination type and image acquisition characteristics including anatomical region imaged;
using said information in automatically selecting a text phrase from a plurality of predetermined text phrases;
automatically populating the selected text phrase into a medical imaging examination report; and
initiating generation of a prompt message for prompting a user for entry of patient specific report data into a specific portion of said report.

16. The method according to claim 15, including the step of
automatically selecting said prompt message from a plurality of predetermined prompt messages.

17. The method according to claim 15, including the step of
automatically using the received patient identifier in identifying a patient medical record and acquiring data indicating said patient diagnosis, said prior medical condition and a current patient medication.

18. The method according to claim 15, including the step of
automatically acquiring data indicating said medical imaging examination type and image acquisition characteristics from an imaging examination system.

19. The method according to claim 15, wherein
said medical imaging examination type comprises at least one of, (a) an MR type, (b) a computed tomography (CT) type, (c) an X-ray type and (d) an Ultrasound type.

20. The method according to claim 19, wherein
said image acquisition characteristics comprise at least one of, (a) a CT scanning trajectory, (b) an MR pulse sequence, (c) an acquired image slice thickness, (d) use of contrast agent, (e) an angle or orientation of imaging and (f) type of synchronization.

21. The method according to claim 15, including the step of
automatically adding a data item identifying a task to a task schedule of a worker in response to data entered into said medical imaging examination report.

22. The method according to claim 15, including the steps of
storing in said at least one repository, data associating a user identifier and user role with said patient and said patient medical history data and
automatically selecting said text phrase from said plurality of predetermined text phrases associated with a plurality of different user roles.

23. The method according to claim 22, wherein
said plurality of predetermined text phrases are customized based on user preference and are associated with a plurality of different users and including the step of
automatically selecting said text phrase from said plurality of predetermined text phrases in response to said user identifier.

24. The method according to claim 15, including the steps of
storing in said at least one repository, data associating a user identifier of a physician providing a second opinion with said patient and said patient medical history data and
automatically selecting said text phrase from said plurality of predetermined text phrases in response to data identifying whether or not an images have been reviewed by said physician.
